(19) United States
(12) Patent Application Publication
(10) Pub. No.: US 2016/0082574 A1
(43) Pub. Date: Mar. 24, 2016

(54) Clamp apparatus

(71) Applicants: Glenn Robinson, Parkland, FL (US); Michael Garcia, Fort Lauderdale, FL (US)

(72) Inventors: Glenn Robinson, Parkland, FL (US); Michael Garcia, Fort Lauderdale, FL (US)

(21) Appl. No.: 14/756,603

(22) Filed: Sep. 22, 2015

Related U.S. Application Data
(60) Provisional application No. 62/071,320, filed on Sep. 22, 2014.

(51) Int. Cl. B25B 5/16; B25B 5/04

(52) U.S. Cl. CPC B25B 5/163; B25B 5/04

(57) ABSTRACT

The present invention provides for a clamp: comprising at least two arms with handles on one end and pivotally attached pads on the opposing ends, a pair of handle covers and at least one spring.

### RELATED APPLICATION

This application is related to U.S. Provisional Application Ser. No. 62/071,320 filed on Sep. 22, 2014 entitled “Clamp Apparatus”.

### BACKGROUND OF THE INVENTION

### Field of the Invention

This invention relates to a tool and more specifically, to a clamp apparatus with pivoting pads and handle covers.

### SUMMARY OF THE INVENTION

In one embodiment, the present invention provides for a clamp comprising: at least two arms, each arm has opposing ends and a protruding element situated between the opposing arms, a first end of the arm comprises a handle, at least a portion of each of the protruding elements contacting one another at a pivot point; at least two contact elements, each of the contact elements is pivotally attached to a portion of a second end of each of the arms; and at least one spring situated at the pivot point.

In another embodiment, the contact elements comprise pads. In yet another embodiment, the pads have central points. In still another embodiment, the pads are pivotally attached to a portion of a second end of each of the arms at the central point of each of the contact elements thereby forming pad pivot points. In still yet another embodiment, the pad pivot points provides for distribution of clamping pressure depending on the item being clamped.

In a further embodiment, the pad pivot points create desired angles between each of the pad when engaged with the item that is clamped thereby preventing marks and damage to the item being clamped.

In another further embodiment, the clamp further comprises at least two pad pins, and the pad pins are selected from a group comprising of fasteners, pins, snap-ons, bolts, screws and combinations thereof.

In yet a further embodiment, the pads are constructed of a material selected from a group comprising of plastic, rubber, polymeric materials and combinations thereof.

In still a further embodiment, the clamp further comprises at least one pivot pin, said pivot pin is selected from a group comprising of fasteners, pins, snap-ons, bolts, screws and combinations thereof.

In still yet a further embodiment, the clamp further comprises at least two handle covers designed to cover at least a portion of each of the handles of each of the arms, each of the handle covers comprises at least two portions, a first external portion and a second interior portion. In another embodiment, the handle covers are constructed of a material selected from a group comprising of plastic, rubber, polymeric materials and combinations thereof.

In another further embodiment, the arm is constructed of a material selected from a group comprising of metal, alloys, hard plastic, hard rubber and combinations thereof. In yet another embodiment, the two arms are generally parallel to one another. In still another embodiment, a portion of each of the two arms overlaps one another forming a scissor effect.

In still yet another embodiment, the two portions of each of the handle covers are secured to one another using a connector selected from a group comprising of fasteners, pins, snap-ons, bolts, screws and combinations thereof.

In a further embodiment, the clamp further comprises at least two inserts designed to fit over a portion of each of the external portions of each of the handle covers.

In another further embodiment, the present invention provides for a clamp comprising: at least two arms, each arm has opposing ends and a protruding element situated between the opposing arms, a first end of the arm comprises a handle, at least a portion of each of the protruding elements contacting one another at a pivot point; at least two handle covers designed to cover at least a portion of each of the handles of each of the arms, each of the handle covers comprises at least two portions, a first external portion and a second interior portion; and at least one spring situated at the pivot point.

In yet another further embodiment, the clamp further comprises at least two inserts designed to fit over a portion of each of the external portions of each of the handle covers. In still another further embodiment, the inserts are constructed of a soft material to form grips on the handle covers.

In a further embodiment, the present invention provides for a clamp comprising: at least two arms, each arm has opposing ends and a protruding element situated between the opposing arms, a first end of the arm comprises a handle, at least a portion of each of the protruding elements contacting one another at a pivot point; at least two pads, each of the pads is pivotally attached to a portion of a second end of each of the arms; at least two handle covers designed to cover at least a portion of each of the handles of each of the arms, each of the handle covers comprises at least two portions, a first external portion and a second interior portion; and at least one spring situated at the pivot point.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is a perspective view of one of the embodiments of the present invention;

FIG. 2 is an exploded side view of FIG. 1 showing the handle cover and inserts; and

FIG. 3 is a side view of another embodiment of the present invention.

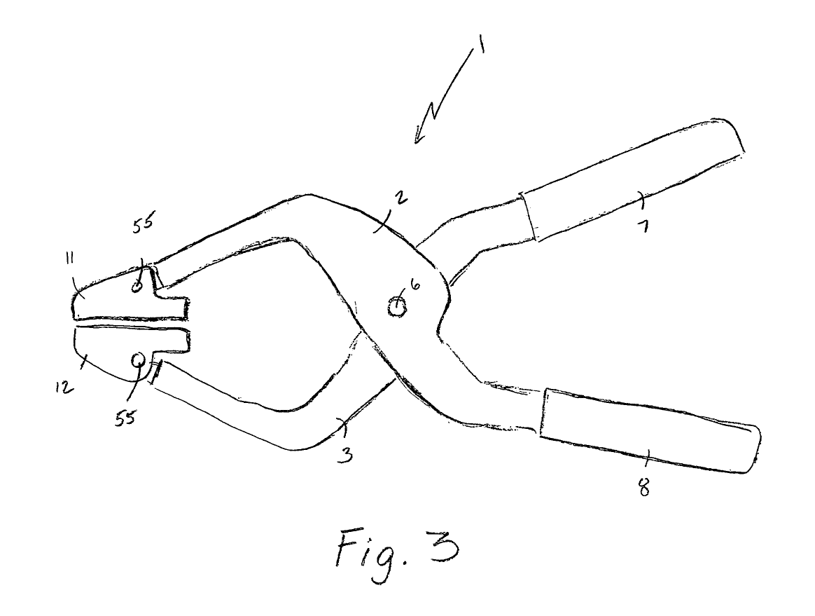

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

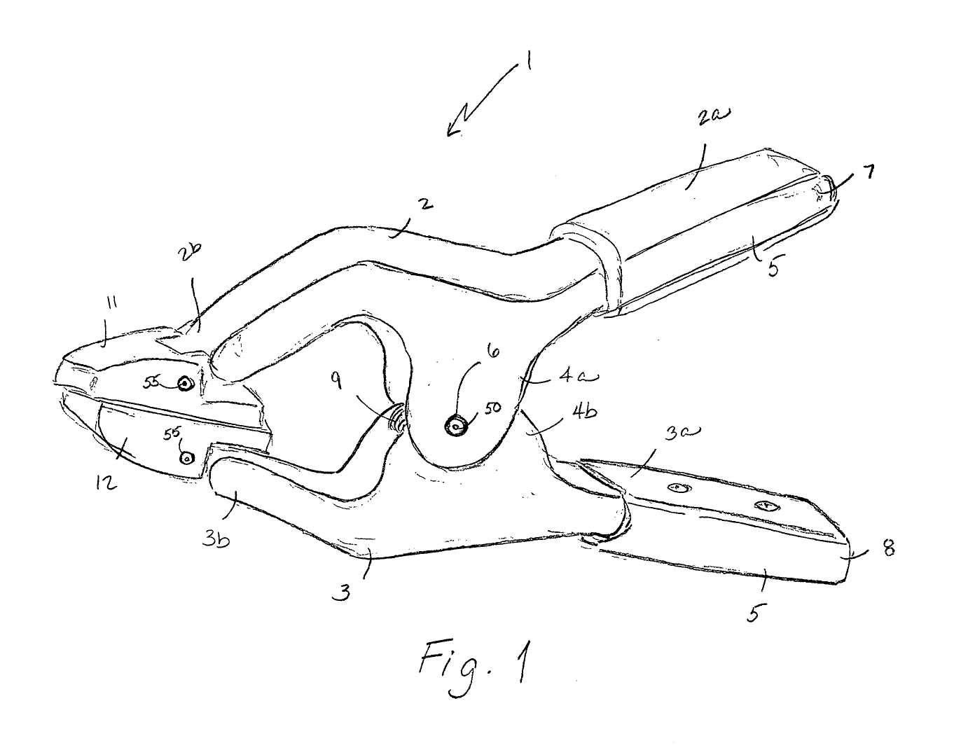

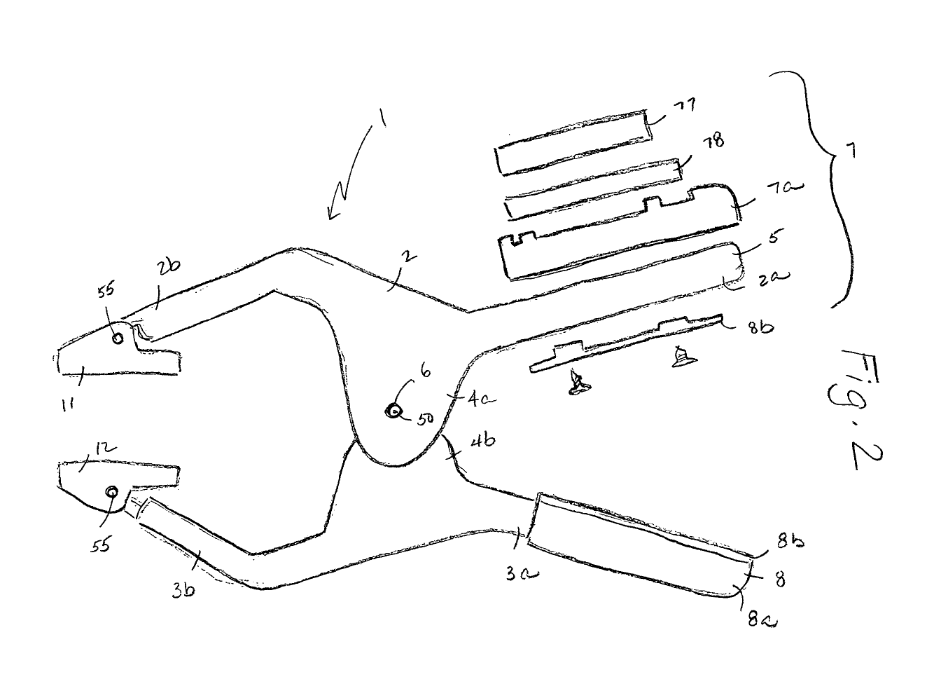

FIGS. 1-2 show one embodiment of the present invention, in particular, a clamp 1 comprising: at least two arms, 2 and 3 respective. The arms have opposing ends, 2a and 2b and 3a and 3b respectively; and protruding elements, 4a and 4b, situated between the opposing arms. A first end (2a or 3a) of the arm (2 or 3) comprises a handle 5, and at least a portion of each of the protruding elements, 4a and 4b, contacting one another at a pivot point 6; at least two handle covers, 7 and 8 respectively, designed to cover at least a portion of each of the handles 5 of each of the arms. The handle covers, 7 and 8, each comprises at least two portions, a first external portion, 7a and 8a, and a second interior portion, 7b and 8b. The clamp 1 also comprises at least one spring 9 situated at the pivot point 6.

The clamp 1 further comprises at least two inserts, 77 and 88, each designed to fit over a portion of each of the external portions, 7a and 8a, of each of the handle covers, 7 and 8. The inserts, 77 and 88, are constructed of a soft material to form grips on the handle covers, 7 and 8. In one embodiment, there is an outer handle insert constructed of TPR 77 and inner cushion constructed of a softer TPR 88.

The clamps are have at least two pads, 11 and 12, pivotally attached to the second ends, 2b and 3b, of the arms, 2 and 3. There is one pivot pin 50 to connect the two arms, 2 and 3, at the pivot point 6 and there are two pad pins 55 to connect each pad (11 or 12) to the second ends 2b and 3b, of the arms, 2 and 3.

In a further embodiment, the two arms, 2 and 3, are generally parallel to one another (FIG. 1-2). In another embodiment, a portion of each of the two arms, 2 and 3, overlaps one another forming a scissor effect.

The mechanism including, but limited to the device for moving the movable element and the pivoting mechanism can be used and interchanged to form various embodiments of the present invention. Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A clamp comprising:
at least two arms, each arm having opposing ends and a protruding element situated between said opposing arms, a first end of said arm comprises a handle, at least a portion of each of said protruding elements contacting one another at a pivot point;
at least two contact elements, each of said contact elements being pivotally attached to a portion of a second end of each of said arms; and
at least one spring situated at said pivot point.

2. The clamp of claim 1 wherein said contact elements comprise pads.

3. The clamp of claim 2 wherein said pads have central points.

4. The clamp of claim 3 wherein said pads are pivotally attached to a portion of a second end of each of said arms at said central point of each of said contact elements thereby forming pad pivot points.

5. The clamp of claim 4 wherein said pad pivot points provides for distribution of clamping pressure depending on the item being clamped.

6. The clamp of claim 5 wherein said pad pivot points create desired angles between each of said pad when engaged with the item being clamped thereby preventing marks and damage to the item being clamped.

7. The clamp of claim 2 further comprises at least two pad pins, said pad pins are selected from a group comprising of fasteners, pins, snap-ons, bolts, screws and combinations thereof.

8. The clamps of claim 1 wherein said pads are constructed of a material selected from a group comprising of plastic, rubber, polymeric materials and combinations thereof.

9. The clamp of claim 1 further comprises at least one pivot pin, said pivot pin is selected from a group comprising of fasteners, pins, snap-ons, bolts, screws and combinations thereof.

10. The clamp of claim 1 further comprises at least two handle covers designed to cover at least a portion of each of said handles of each of said arms, each of said handle covers comprises at least two portions, a first external portion and a second interior portion.

11. The clamp of claim 10 wherein said handle covers are constructed of a material selected from a group comprising of plastic, rubber, polymeric materials and combinations thereof.

12. The clamp of claim 1 wherein said arm is constructed of a material selected from a group comprising of metal, alloys, hard plastic, hard rubber and combinations thereof.

13. The clamp of claim 1 wherein said two arms are generally parallel to one another.

14. The clamp of claim 1 wherein a portion of each of said two arms overlaps one another forming a scissor effect.

15. The clamp of claim 10 wherein said two portions of each of said handle covers are secured to one another using a connector selected from a group comprising of fasteners, pins, snap-ons, bolts, screws and combinations thereof.

16. The clamp of claim 10 further comprising at least two inserts designed to fit over a portion of each of said external portions of each of said handle covers.

17. A clamp comprising:
at least two arms, each arm having opposing ends and a protruding element situated between said opposing arms, a first end of said arm comprises a handle, at least a portion of each of said protruding elements contacting one another at a pivot point;
at least two handle covers designed to cover at least a portion of each of said handles of each of said arms, each of said handle covers comprises at least two portions, a first external portion and a second interior portion; and
at least one spring situated at said pivot point.

18. The clamp of claim 17 further comprising at least two inserts designed to fit over a portion of each of said external portions of each of said handle covers.

19. The clamp of claim 18 wherein said inserts are constructed of a soft material to form grips on said handle covers.

20. The clamp of claim 17 wherein each of said two arms are generally parallel to one another.

21. The clamp of claim 17 wherein a portion of each of said two arms overlap one another forming a scissor effect.

22. A clamp comprising:
at least two arms, each arm having opposing ends and a protruding element situated between said opposing arms, a first end of said arm comprises a handle, at least a portion of each of said protruding elements contacting one another at a pivot point;
at least two pads, each of said pads being pivotally attached to a portion of a second end of each of said arms;
at least two handle covers designed to cover at least a portion of each of said handles of each of said arms, each of said handle covers comprises at least two portions, a first external portion and a second interior portion; and
at least one spring situated at said pivot point.
